(19) United States
(12) Patent Application Publication
(10) Pub. No.: US 2025/0014132 A1
(43) Pub. Date: Jan. 9, 2025

(54) COMPREHENSIVE TURNKEY ESTATE AND LIFE PLANNING TRANSITIONING SYSTEM AND METHOD OF USE

(71) Applicant: KEVIN J. WILLIS, Woodbridge, VA (US)

(72) Inventor: KEVIN J. WILLIS, Woodbridge, VA (US)

(21) Appl. No.: 18/219,650

(22) Filed: Jul. 8, 2023

(51) Int. Cl. G06Q 50/18; G06F 21/32

(52) U.S. Cl. CPC G06Q 50/186; G06F 21/32

(57) ABSTRACT

A comprehensive and user-friendly life transitioning system. The system herein provides a comprehensive, or turkey, system that guides a user or users through every likely step of personal end-of-life planning, and assists those left behind afterward. The system herein provides a complete system, including the use of at least one computerized device and system software, to enable a decedent, and those responsible for handling decedent's affairs, to provide and implement decisions, information, steps, and documents for completion for handling in advance (including the steps of legal and financial preparation), for medical, financial, grief assistance, and other end of life matters. The system software allows a user to prepare and move through a number of distinct modules covering an array of tasks to be completed across a distinct set of phases

### TECHNICAL FIELD OF THE INVENTION

The present invention relates to the general field of end-of-life planning, and specifically to computerized systems for planning and conducting end of life and post end of life transitional planning.

### BACKGROUND

Your loved one—your mother father, your brother, your sister, or perhaps someone else—is about to pass. They've placed their trust in you to work everything out before or after they're gone. Medical decisions, legal decisions, financial decisions, Insurance, funeral, paying costs and disbursement of assets, and coordinating activities with other family members and friends, are just a few issues that might be placed with you. How the person you're responsible for does feel about end-of-life decisions, and where are those documents? Where is the deed to the home? Where are the insurance policies? What online accounts and bill pays are there, and where are the passwords for them? Whose approval is needed for doing what?

Then when the decedent passes, someone has to write an obituary (often trying to remember or ask around for complete information), and funeral planning may or may not be done in advance or have to be done on the spot at a funeral home. Because of possible, or even likely information gaps regarding a decedent, some items may not be finished, or may not be finished correctly.

Or perhaps, possibly worse, the decedent has made no arrangements. It falls to you to handle these decisions, but you are not sure of so much. Or perhaps it is unclear who these responsibilities are even supposed to fall to. Additionally, perhaps you get along with all other involved family members and can make decisions with agreement and unity. But maybe you do not, and cannot.

These are just a few of the factors that can (and often do) make life planning, at the least difficult, and sometimes completely overwhelming. Worse yet, these decisions and needed activities, by their nature, tend to arrive at the worst possible time; when loved ones are in the midst of grief. Excess stress is rarely a good thing, but to have excess stress at this ultimate time of grief, to have loved ones additionally worrying about end-of-life issues, brings additional suffering to them.

Further still, because estate planning is at the intersection of a number of areas (processing grief, legal, financial, event planning, etc), it can become a bewildering morass of wandering in multiple directions and chasing down previously unrelated bits of information. This often results in a process that is often piecemeal, disorganized, and bewildering.

In addition, with multiple family members or friends possibly involved, and the decedent not around to settle issues or supply now missing information, disputes can, and often do, arise. Sometimes, disputes can happen because one or more relatives or other parties, as is often portrayed, is simply greedy and out to get whatever they can. However, very often, disputes happen because even though there are no dark motives, people simply honestly remember things such as conversations in the past differently. Or sometimes, different people might have been told different things at different times. Or if information about a matter is not known, (e.g., what the decedent wanted done with their remains) and everyone is left to speculate, different people may speculate differently.

While disputes sometimes arise regarding matters like funeral planning, writing obituaries, tombstone, cremation and the like, a decedent's family and friends may be simply left in the dark because these matters were not discussed, and there is no information, in any form, about them.

Currently, there are some individual software applications for individual matters. For example, applications in which a user inputs data to accomplish individual tasks, or gathering data for individual portions of estate planning, placing them in a computer-readable format, then providing the data upon request are known. Applications, or planning notebooks, that, for example, gather date for individual items such as gathering financial data or funeral planning, then place this data in computer-readable format, and make this data available upon a specific event for planning purposes, are also known in the art. Further, automating some financial steps, as is done in a number of financial systems, is known in the art. Generally, gathering data, computerizing it, and distributing the data at a determined time to assist in some steps of estate planning are known in the art.

However, these applications not only fail to address the issue of limited and isolated portions of end-of-life planning and execution, but they are examples of it. These applications, planning notebooks, and the like do not address the overall issue of the process remaining in multiple separate piecemeal portions that still must be known, pulled together, and executed by a user who may or may not be aware of the decedent's information, and is most likely in profound grief.

These limited applications and processes also tend to gravitate towards, albeit in a limited way, financial matters. They do not tend to assist with more emotional (but at least equally important) parts of the process, such as providing ways for loved ones to handle grief or remember the departed. Finally, though some steps are computerized or simplified, none of these inventions solves the problem herein; providing a decedent and loved one peace of mind and assurance that most or all of the end-of-life matters are in hand and within the capabilities and knowledge of the person left to handle them.

Little wonder, then, that repeated polling and surveys show that typically more than half of Americans do not have a will prepared, meaning that their state will make their estate decisions for them. Gallup polling since 1990 indicates the percent of Americans with a will has varied very little; from 44 to 51%, with the latest polling resting at 46%. Further, according to a CNBC.com article (“67% of Americans Have no Estate Plan, Survey Finds. Here's How to Get Started on One”, Apr. 11, 2022) (which is representative of a number of articles discussing this same set of issues) the reasons most Americans do not have an estate plan of any kind include:
They just haven't gotten around to it.

Applicant submits that it's not a great leap to believe a large part of this reason is people often feeling overwhelmed by the process. Feeling they do not even know where to begin, so “don't' get around to it.”
Belief that they don't “have enough assets to pass on to their loved ones.”
   This belief fails to realize, or deal with, the fact that the universe of decisions in estate planning comprises much more than simply dividing assets.
Belief that the estate-planning process is too costly.
   Sometimes, this is sadly correct. The process can be both costly and very time consuming.
Not knowing how to get a will done.
   This appears to directly relate to already-noted issues of being overwhelmed by the process, and not knowing where to begin.

There are some software applications (apps) available to attempt to deal with aspects of this overwhelming process, but currently nothing has really dealt with this overall issue. Even with such apps available, personal and estate planning is still rather haphazard and likely to involve working with multiple parties, apps, or some mixture. One might go to an attorney or software to write a will. Then one might go to somewhere else and/or use other software for medical proxy planning.

Currently, there are some individual software applications for individual matters. For example, applications in which a user inputs data to accomplish individual tasks, or gathering data for individual portions of estate planning, placing them in a computer-readable format, then providing the data upon request are known. Applications, or planning notebooks, that, for example, gather date for individual items such as gathering financial data or funeral planning, then place this data in computer-readable format, and make this data available upon a specific event for planning purposes, are also known in the art. Further, automating some financial steps, as is done in a number of financial systems, is known in the art. Generally, gathering data, computerizing it, and distributing the data at a determined time to assist in some steps of estate planning are known in the art.

However, these applications not only fail to address the issue of limited and isolated portions of end-of-life planning and execution, but they are examples of it. These applications, planning notebooks, and the like do not address the overall issue of the process remaining in multiple separate piecemeal tasks that still must be known, pulled together, and executed by a user who may or may not be aware of the decedent's information, and is most likely in profound grief.

These limited applications and processes also tend to gravitate towards, albeit in a limited way, financial matters. They do not tend to assist with more emotional (but at least equally important) parts of the process, such as providing ways for loved ones to handle grief or remember the departed. Finally, though some steps are computerized or simplified, none of these inventions solves the problem herein; providing a decedent and loved one peace of mind and assurance that most or all of the end-of-life matters are in hand and within the capabilities and knowledge of the person left to handle them.

The current processes can best be described as piecemeal, chaotic, and difficult to completely plan, with a likely number of unwanted surprises along the way. What is needed is a process that provides peace of mind for a transitioning person, as well as those planning their estate and medical matters, and friends and loved ones, by providing an improved and turnkey solution to life transitioning planning and implementation.

### SUMMARY

A comprehensive and user-friendly life transitioning system is shown and described herein. It is to be understood that the term “transition” is used herein as a construct to loosely identify a phase in the life planning, death, and post-death cycle of a person. A turnkey estate and life planning transitioning system is disclosed. The system herein provides a way of helping a person transition from life to death, along with the person or persons planning and handling the transition phases. The system provides a software application, in conjunction with a single up to a network of computerized devices, that provides pre-transition, time of transition, and post-transition planning and means of execution. The system further provides this planning and execution assistance across a comprehensive array of life, medical, personal, support, financial, and estate areas.

The system herein provides a comprehensive, or turnkey, system that guides a user or users through every likely step of personal end-of-life planning, leaving most to all essential steps completed before a user transitions (passes). In later phases, the system greatly reducing stress on survivors such as friends and loved ones.

The system is comprised, generally of;
an Initial Transition Preparation phase,
a Pre-transition phase,
a Transition phase,
a Post transition phase, and
a Transition to Future phase.

The array of tasks to be completed can be aligned into a number of manageable modules. These modules can include.
Pre-transition care and emergency care module,
a Burial and funeral service planning module,
an Estate and inheritance planning and execution module,
an Emotional and grief assistance module, and
an Other Matters module.

Each module consists of a set of related tasks to be carried through the phases, and executed using at least one computer, server, or both.

Before the Transition Preparation phase proceeds, pre-programmed transitioning application software is programmed and placed into any suitable computerized device, which can be accessed by a user, or users.

After the application software is programmed and placed onto the at least one computerized device or placed onto the server, an at least one user begins the process by accessing the software in the computerized device or server.

The user and a successive user use an interface to interact with the software. The software is located either on the computerized device, the server, or both. As the user or successive user is guided through the phases of the system, the user enters information and commands via the interface, which are transmitted to the software, which acts interactively, via the computer, server, or both, with the user or successive user. The software is stored and supported either on the computerized device, server or a combination of these, as well as the carrying out of commands by the user or successive user.

The respective modules are conducted through the phases, such as the Initial Transition Preparation phase. In the pre-transition care and emergency care module, the at least one user can set up the system with access criterion, such as username(s) and security access means. The system presents the user with an option of working with an attorney to prepare a living will, and medical power of attorney; or to obtain a state-specific living will template and prepare their living will using the form and do likewise for a medical power of attorney.

In either case, the system can provide a checklist of items for living will and medical power of attorney preparation. Steps can include deciding who will hold the medical power of attorney and make care decisions, confirming the medical power of attorney and living will, confirming execution and notary of these documents, and either confirming filing, or location(s) where these documents can be found.

The creation of a living will can be accomplished by the system providing a reminder to see an attorney, or create one, providing a state-specific form, to be filled out and filed. In either case, a list of steps to accomplish the task can be filled out and included.

The user can also name a personal doctor and include information about the doctor, such as contact information. The user can also name and making arrangements for any future nursing home care.

The system can also provide software enabling the Decedent to create audio or video media recordings to make the Decedent's wishes on these matters clear.

The system can integrate with the recording software of the computer or server so that a user can record and create any recordings. The decedent can use these recordings to create a record of their wishes regarding emergency and medical matters. Any recordings can then be saved for future play at the appropriate time.

These recordings can, additionally, be time stamped and stored to provide a record of when they were made. For example, a user can make clear their wishes regarding who they want as a medical power of attorney, or life support and living will matters, or their wishes about handling emergency care and continuing care (e.g., nursing home) situations. These recordings can supplement documents like a living will or medical power of attorney. Such supplementation and added clarity can avoid both legal disputes and acrimonious family disputes.

The Burial and funeral service planning module can also be accessed and completed by a user. The system can help a user work through acquiring a burial plot. The system inquires if a user wishes to pursue the option of purchasing a burial plot in advance (or multiple plots for family members) and if so, provides a checklist for completion. The checklist can include asking for information about location of plot, and confirming purchase by the user. The system can record the information about the plot and at the appropriate time (after acquisition and before the funeral) a successive user can provide the information to a funeral planner or anyone else who needs to know.

Similarly, if cremation is used, the user can arrange the cremation by providing information about the cremation, such as what kind of urn is to be used, whether the ashes are to be scattered or stored, and in each case, where. The system can arrange for a tombstone. The system can supply the user requests for information about any tombstone, such as whether to have one, what should be written on it, any designs, and what company or person should be used to create the stone.

Further, system can then move to requesting information for the obituary, which the user and/or Decedent can supply. This can include items such as birth dates, key life points, relatives, friends, and survivors.

Turning to the Estate and inheritance planning and execution module, the system helps the decedent, as well as possibly the user, decide a method for drafting a will, and possibly for the decedent to consult with a recommended attorney.

The system provides the options of either preparing a list of information and intentions to take to an attorney to draft a will, or can provide a state-specific form to be filled out, and the decedent to sign.

In another embodiment, an AI system can be used to guide the decedent through a list of pre-prepared questions and even engage in discussion with the decedent, until the decedent's intentions are clear. The system can then further create an appropriate legal document; which, depending upon the state of the law within the jurisdiction, the system may authenticate or validate its own authenticity itself, or have the prepared document to present to an attorney for legal completion.

In either case, the system provides a checklist of steps from providing information to final execution and filing. The system, with either option, can lead the decedent through a questionnaire type format so that executor, beneficiaries, and who collect s which inheritance, can all be gone through and laid out.

The system can also, if it determines a trust would be helpful to achieving a decedent goal, recommend the trust be completed by an attorney, and can provide information gathering and a checklist so that the decedent can assist the attorney in this process.

In other embodiments, a will or trust can be created, executed, and stored in a digital formal by any means suitable in the art. The system can ask the user a series of questions via computer. The user directly inputs requested information and answers a series of question. This information is then taken by the system, placed within a will or trust template, and the proper document created. Then the user can execute the document via any suitable means of digital execution in the art. Further, a supplemental audio or video recording can be created explaining any will or trust decisions.

The system can also have a grief assistance and memories module, to help those left behind process the loss. This grief assistance and memories module provides multiple ways to help those left behind stay connected. The decedent can create video or audio messages. These can be general messages, or specific messages targeted to specific people. Further, the decedent can create one or more virtual activities and designate the message to be accessed by any person(s) they choose. This experience can be enhanced if the video is in a format such as Virtual Reality, which can make the viewer feel more like they are there with the decedent.

Turning to the Pre-transition phase, now that the software has been programmed and placed into the system and the at least one user has set up the software use through the modules, use of the software through pre-transition matters-before the death of the decedent-begins.

If the decedent ends up in an end-of-life care type situation, the living will the system assisted with creating can, depending upon the situation, be accessed and presented by either the decedent or designated user. The medical power of attorney can also be presented by the decedent or user. If the decedent needs to enter nursing care, of their own decision or the holder of the medical power of attorney, the nursing care arrangements can be accessed and activated. Any audio or visual recordings about these matters can, as appropriate, be accessed and played.

Turning to the Transition Phase, the successive user(s) access the system and its transitioning application software. Once the system is accessed, the successive user can begin burial and funeral service planning. If the decedent acquired a burial plot, the successive user can access the information about the burial plot and arrange for placement of the decedent in the plot. If the decedent made arrangements for cremation, the information and any arrangements about cremation are accessed and carried out. Whether decedent is buried or cremated, if decedent has arranged for a tombstone, the successive user can carry out these arrangements and secure and place the tombstone. If Obituary information was supplied, the successive user can access and supply this obituary information.

The will may be accessed by the executor or other designated party. The will can then be read or otherwise disseminated to the appropriate parties at this time, and they be informed of the contents of the will. Any appropriate parties may also be informed of any trusts. Any supplemental information that was entered to help carry out the will can now be accessed by the executor or other appropriate party. If supplemental recordings were created in support or explanation of the will (and any trusts), these can be accessed and played to the designated parties.

Portions of the Grief assistance and memories module may become involved any time from decedent's death to the distant future Any video or audio recordings, including those containing messages that were created by decedent to help others in the immediate aftermath of their passing can be played for any designated person at any point during this time. The decedent may even have an audio or video recording to be played at their own service.

Turning to the Post Transition phase, any matters of the Estate and inheritance planning and execution module that have not been resolved in a previous phase are to be completed and resolved in this phase. If it has not already been, the will may be accessed by the executor or other designated party. The will can then be read or otherwise disseminated to the appropriate parties, and they be informed of the contents of the will. Any appropriate parties may also be informed of any trusts (which may be noted in the will).

Supplemental information that was entered to help carry out the will can now be accessed by the executor or other appropriate party. If supplemental recordings were created in support or explanation of the will (and any trusts), these can, if not already, be accessed and played to the designated parties.

The grief assistance and memories module provides multiple ways, as the death and funeral service recede, to help those left behind through their grief and to stay connected. If the decedent has created video or audio messages, these can be played to any designated persons during this period. These can be a single, or series, of messages to any, or a set of, designated persons. These messages can be crafted to give any last thoughts or advice, help them with their grief, or say other things the decedent wanted to. If the decedent opted to create one or more virtual activities, any designated person or groups can access and run any of these virtual activities.

Turning to the Transition to Future phase, this phase begins after the Post transition phase; typically within a few months of the decedent passing. It typically is centrally, or completely, about helping relatives and friends of the decedent handle ongoing grief, keeping memories of the decedent alive, and maintaining an extended connection to the decedent.

If the decedent has created audio or visual recordings and activities meant for relatives or friends of the decedent to access over a longer-term timeline, these, as previously noted, can be accessed by designated person(s) at specific times. The decedent can make these recordings for specific people or groups. If the decedent opted to create one or more virtual activities any designated person or groups can access and run any of these virtual activities.

In other embodiments, the at least one server can be set up to be run by a central server. The server can be on a network with multiple computerized devices.

In other embodiments, the decedent, user or other designated party can create a picture bank of uploaded and stored pictures. Access to different files within the bank can be decided and given out accordingly, and files or access can be pre-determined to be shared or granted at specific times or upon specific events.

The system herein provides a complete system for enabling a decedent, and those responsible for handling decedent's affairs, to provide decisions, information, steps, and documents for completion for turnkey handling in advance (including the steps of legal and financial preparation), for medical and end of life matters.

### BRIEF DESCRIPTION OF THE DRAWINGS

FIG. 1 is a schematic diagram of an overall embodiment of the invention.

FIG. 2 is a schematic diagram of the embodiment of FIG. 1, showing additional modules,

FIG. 2a is a schematic diagram of a part of the embodiment of FIG. 1 featuring an expanded view of additional steps.

FIG. 3 is a schematic diagram of a transitional phase of the embodiment of FIG. 1.

FIG. 4 is a schematic diagram of a transitional phase of the embodiment of FIG. 1.

FIG. 5 is a schematic diagram of a transitional phase of the embodiment of FIG. 1.

FIG. 6 is a schematic diagram of a transitional phase of the embodiment of FIG. 1.

FIG. 7 is a schematic diagram of a transitional phase of the embodiment of FIG. 1.

FIG. 8 is a schematic diagram of a further embodiment of the basic system featured in FIG. 1.

### DETAILED DESCRIPTION OF PREFERRED EMBODIMENTS

Shown and described herein is a comprehensive and turnkey estate and life planning transitioning system. The system herein provides a way of helping a person transition from life to death, along with the person or persons planning and handling the transition phases (particularly post transition). The system 10 provides a software application, in conjunction with a single up to a network of computerized devices 12, 12a, 12b, that provides pre-transition, time of transition, and post-transition planning and means of execution. The system further provides this planning and execution assistance across a comprehensive array of life, medical, personal, support, financial, and estate areas.

The system herein 10 provides a comprehensive, or turnkey, system that guides a user or users through every likely step of personal end-of-life planning, leaving most to all essential steps completed before a user transitions (passes). In later phases, the system 10 greatly reducing stress on survivors such as friends and loved ones.

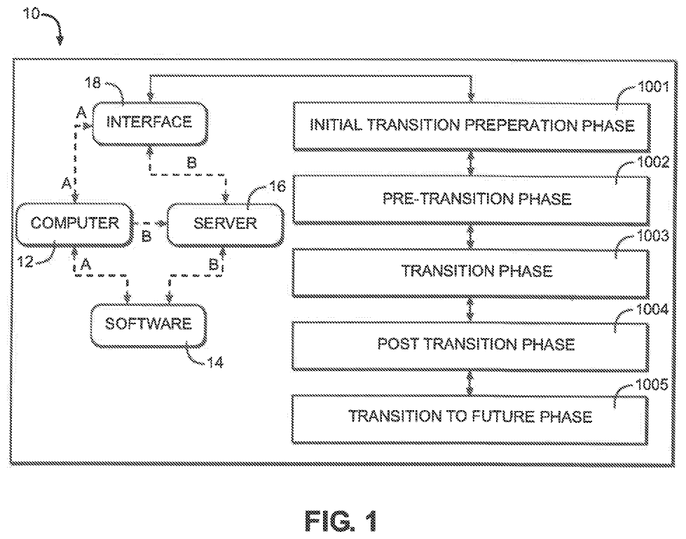

Turning to FIG. 1, the system 10, is comprised, generally, of;
an Initial Transition Preparation phase 1001,
a Pre-transition phase 1002,
a Transition Phase 1003
a Post transition phase 1004, and
a Transition to Future phase 1005.

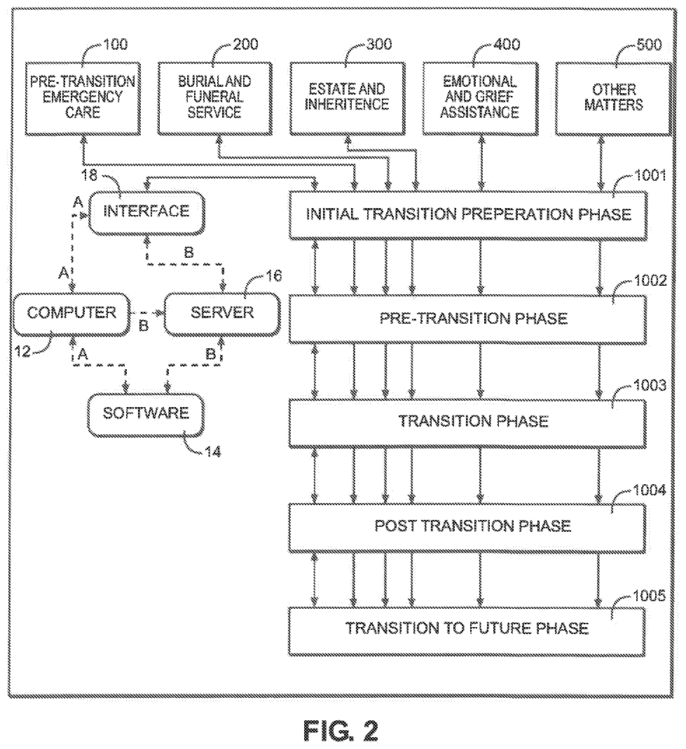

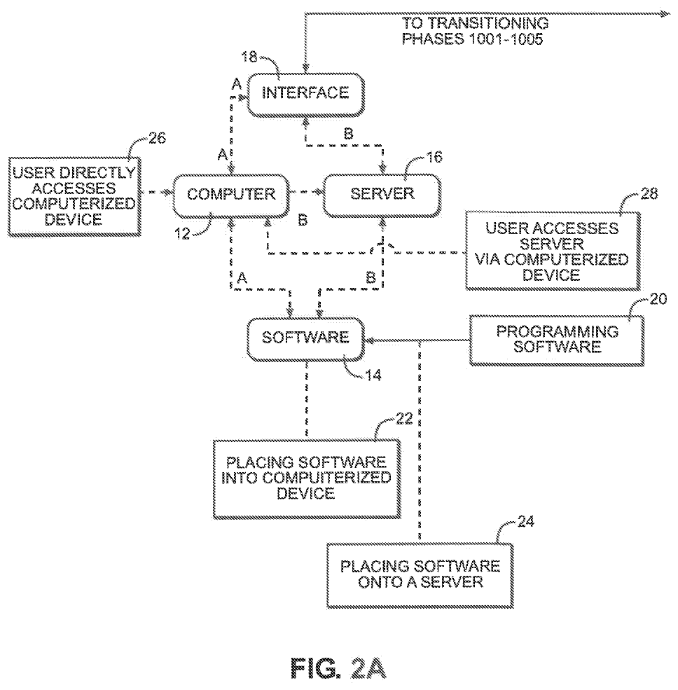

Turning to FIGS. 2, generally, the array of tasks to be completed can be aligned into a number of manageable modules. In an embodiment of the application platform, these modules can include.
Pre-transition care and emergency care module 100,
a Burial and funeral service planning module 200,
an Estate and inheritance planning and execution module 300,
an Emotional and grief assistance module 400, and
an Other Matters module 500.

Each module 100, 200, 300, 400, 500 consists of a set of related tasks to be carried through the phases 1001, 1002, 1003, 1004, 1005, and executed using at least one computer 12, server 16, or both.

Turning to FIG. 2A, before the Transition Preparation phase 1001, can proceed, pre-programmed transitioning application software 14 is programmed 20 and placed into any suitable computerized device 12, which can be accessed by a user, or users. In one embodiment of the application platform, the software is placed directly 22 onto a user computer 12. The computerized device 12 can be any suitable electronic device as known in the art, such as, but not limited to, a personal computer, laptop, server, smart tablet, or smartphone. The computer can be accessed via any suitable interface 18.

In a possible embodiment of the system 10, the software 14 is placed 24 onto a server 16. The server be any suitable electronic device as known in the art, such as, but not limited to, a personal computer, laptop, server computer, tablet, or Smartphone. The server 16 and the software 14 on it can be accessed directly, or interactively via the at least one computerized device 12.

After the application software 14 is programmed and placed 22 onto the at least one computerized device 12 or placed 24 onto the server 16, an at least one user begins the process by accessing the software 14 in the computerized device 12 or server 16. In one embodiment of the application platform, the at least one user can access the software 14 by directly accessing it on the computerized device 12, 26. In another embodiment, the at least one user can access the software 14 more indirectly by accessing the software on the server 16, either directly or via the computerized device 12, 28.

Herein, it is to be understood that the term “decedent” is the person end of life (or “transitioning”) planning is being done for. The decedent is the primary party in decision-making and direction. It is to be understood that though the term “decedent” is used, this person would obviously be alive during the steps before their death. A user is at least one person using the system before the Decedent's death. This user can be the Decedent, at least one person chosen by the Decedent, or both. The user tends to be the at least one person who set up the system 10 for use. A successive user is at least one person appointed by the Decedent to access and use the system 10 after the Decedent's death, and implement the directives created for the system 10. The successive user(s) can be the same at least one person as the user (if the user is appointed by the Decedent as well), or may be different. The successive user can be the same at least one person as the executor of the Decedent's estate, or the successive user may be different, dealing with matters other than the will and estate.

Returning briefly to FIGS. 1-2. The basis relationship between the phases 1001, 1002, and, 1003, 1004, 1005 and the hardware and software components of the system 10 is shown. The user and successive user use the interface 18 to interact with the software 14. The software 14 is located either on the computerized device 12, the server 16, or both. As the user or successive user is guided through the phases 1001, 1002, and, 1003, 1004, 1005 of the system, the user enters information and commands via the interface, which are transmitted to the software 14, which acts interactively, via the computer 12, server 16, or both, with the user or successive user. The software is stored and supported either on the computerized device 12, server 16 or a combination of these, as well as the carrying out of commands by the user or successive user.

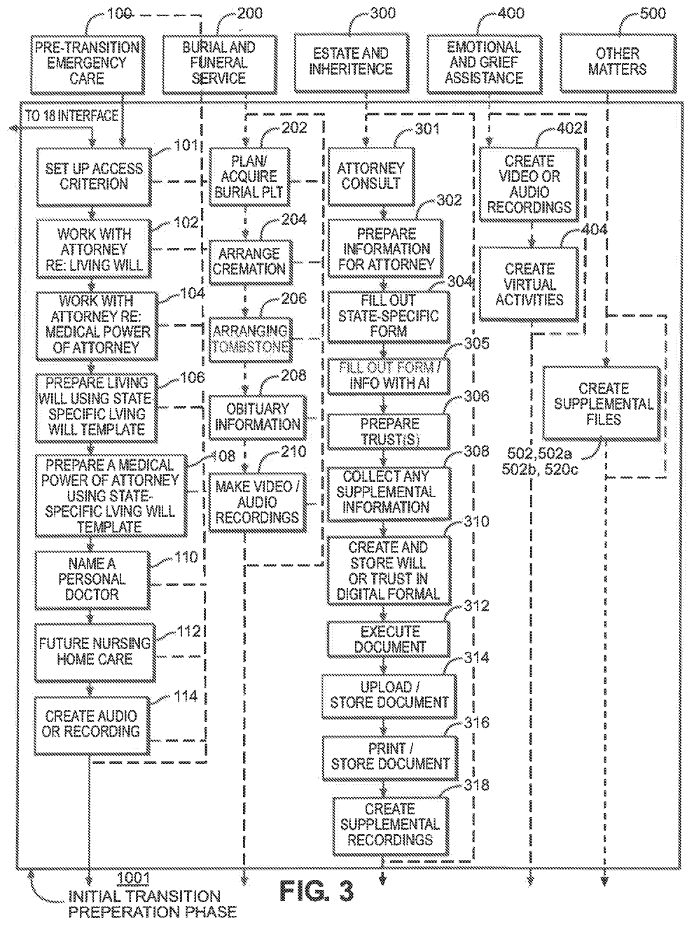

Turning to FIG. 3, the conducting of respective modules 100-500 through the Initial Transition Preparation phase 1001 is shown.

Turning to the pre-transition care and emergency care module 100, the at least one user can set up the system 10 with access criterion, such as, e.g., username(s) and security access means 101. The access means can include any means of accessing software known in the art. The programmed tasks of this phase 100 are shown. The system 10 presents the user with an option of working with an attorney to prepare a living will 102 (stating conditions under which care should not continue), and medical power of attorney (stating who will make medical decisions in case of incapacity) 104; or to obtain a state-specific living will template 106 and prepare their living will using the form and do likewise for a medical power of attorney 108.

In either case, the system 10 can provide a checklist of items for living will and medical power of attorney preparation. Steps can include deciding who will hold the medical power of attorney and make care decisions, confirming the medical power of attorney and living will, confirming execution and notary of these documents, and either confirming filing, or location(s) where these documents can be found.

The creation of a living will 102 can be accomplished by the system 10 providing a reminder to see an attorney, or create one, providing a state-specific form 106 (upon entry of a location by the user) to be filled out and filed. In either case, a list of steps to accomplish the task can be filled out and included.

The user can also name a personal doctor 110 and include information about the doctor, such as contact information. The user can also name and making arrangements for any future nursing home care 112.

The system 10 can also provide software enabling the Decedent to create audio or video media recordings 114 to make the Decedent's wishes on these matters clear. The audio can be comprised of any suitable technology in the art, such as, but not limited to,
.3gp, .8svx, .aa, .aac, .aax, .act, aes3, Adaptive differential pulse-code modulation, Adaptive Multi-Rate audio codec, Advanced Systems Format, Advanced Audio Coding, .aiff, .alac, .amr, .ape, .au, .awb, Audio Video Interleave, Broadcast Wave Format, .cda, Core Audio Format, Digital Audio Tape, .dss, .dvi, Dialogic ADPCM, .flac, GBA Sound Format, .gsm, .iklax, .ivs, Linear Pulse Code Modulation, .m4a, .m4b, .m4p, MIDI, .mmf, MPEG-1, MPEG-4, .mp3, .mp4, .mpc, .msv, Multimedia, Musepack, .nmf, .ogg, .oga, .mogg, Original Sound Quality, Pulse-code modulation, .opus, QCP, .ra, .rm, .raw, .rf64, .sin, Speex, .tta, Theora, .voc, Vorbis, .vox, .wav, .wma (Windows Media Audio), .wv, .webm, and/or XM.

Likewise, the video can be comprised of any suitable technology in the art, and any suitable video format in the art. Formats can include, but are not limited to, MP4, MOV, WMV, AVI, AVCHD, FLV, F4V, and SWF, MKV, WEBM, MPEG, or MPEG-2. Technologies can also include, but are not limited to a regular video format, Virtual Reality format, or a high resolution system such as IMAX™.

The system 10 can integrate with the recording software of the computer 12 or server 16 so that a user can record and create any recordings. The decedent can use these recordings to create a record of their wishes regarding emergency and medical matters. Any recordings can then be saved for future play at the appropriate time.

These recordings can, additionally, be time stamped and stored to provide a record of when they were made. For example, a user can make clear their wishes regarding who they want as a medical power of attorney, or life support and living will matters, or their wishes about handling emergency care and continuing care (e.g., nursing home) situations. These recordings can supplement documents like a living will or medical power of attorney. Such supplementation and added clarity can avoid both legal disputes and acrimonious family disputes.

For example, if a father makes clear in his own voice or video it is his choice to appoint Sister A to handle such matters, Brother B may not be happy about it, but will have a much harder time fighting Sister A on the matter. Possibly more importantly, this could well prevent Brother B from holding it personally against Sister A.

The Burial and funeral service planning module 200 can also be accessed and completed by a user. The system 10 can help a user work through acquiring a burial plot 202. The system inquires if a user wishes to pursue the option of purchasing a burial plot in advance (or multiple plots for family members) and if so, provides a checklist for completion. The checklist can include asking for information about location of plot, and confirming purchase by the user. The system 10 can record the information about the plot and at the appropriate time (after acquisition and before the funeral) a successive user can provide the information to a funeral planner or anyone else who needs to know.

Similarly, if cremation is used, the user can arrange the cremation 204 by providing information about the cremation, such as what kind of urn is to be used, whether the ashes are to be scattered or stored, and in each case, where. The system 10 can arrange for a tombstone 206. The system 10 can supply the user requests for information about any tombstone, such as whether to have one, what should be written on it, any designs, and what company or person should be used to create the stone.

Further, the system 10 can then move to requesting information for the obituary 208, which the user and/or Decedent can supply. This can include items such as birth dates, key life points, relatives, friends, and survivors. As the Decedent is in the best position to know this information about themselves, it can be easily gathered and stored at this point.

While these steps likely have value in reducing disputes, it's other (and possibly primary) value is to simply provide information and direction about these matters. With information about these matters input into the system 10, what the Decedent wanted done with their remains, what service they wanted, what information should be in their obituary and other matters is now entered and known.

As with the pre-transition care and emergency care module 100, the Decedent can make video or audio recordings 210 to be stored until the appropriate time, explaining their wishes and plans. The successive user, as well as other family and friends, can be assured what the Decedent wanted

Turning to the Estate and inheritance planning and execution module 300, the system 10 helps the decedent, as well as possibly the user, decide a method for drafting a will 302, 304, and possibly for the decedent to consult with a recommended attorney 301.

In one embodiment, a group of attorneys can be collected and placed into the system, such as within a database. The group of attorneys can be pre-screened for qualification in this area, so a group of qualified attorneys can be offered to the decedent, or decedent and user, if they are interested, to create a referral attorney network. In an embodiment, the attorneys within the network can pay a maintenance, brokerage or other similar fee to be in the network, which can provide an additional source of revenue. Further, a decedent or user can personally consult with a chosen attorney, or the video technology of the system 10 can be used to create video consultations with in-network attorneys 301. This can greatly increase convenience and options for the decedent or user. The system 10 can, thereby, supply the decedent or user quick and convenient access to pre-screened, qualified attorneys in specified areas without having to leave their own home.

The system 10 provides the options of either preparing a list of information and intentions to take to an attorney to draft a will 302, or can provide a state-specific form to be filled out 304, and the decedent to sign. For example, the device can provide a “fill in the blank” version of a simple will that is set, by state, for legality. The system 10 can even be programmed, past a certain level of complexity of planning a will and estate, to tell a decedent to seek an attorney.

In another embodiment, an AI system can be used to guide the decedent through a list of pre-prepared questions and even engage in discussion with the decedent, until the decedent's intentions are clear 305. The system 10 can then further create an appropriate legal document; which, depending upon the state of the law within the jurisdiction, the system 10 may authenticate or validate its own authenticity itself, or have the prepared document to present to an attorney for legal completion.

In either case, the system 10 provides a checklist of steps from providing information to final execution and filing. The checklist can also note the location where the will is kept or has been filed, so it can be found more easily. The system 10, with either option, can lead the decedent through a questionnaire type format so that executor, beneficiaries, and who collect s which inheritance, can all be gone through and laid out. The system 10 can also provide preparation of any needed trusts 306. In an embodiment of the application platform, this can be done by a pre-programmed questionnaire, and list of trust options.

Whichever option of will preparation 302, 304 is chosen, the system 10 will, if it determines a trust would be helpful to achieving a decedent goal, recommend the trust be completed by an attorney, and can provide information gathering and a checklist so that the decedent can assist the attorney in this process. Having a decedent who knows what they want to do, and a clear listing of intentions and goals, can assist an attorney greatly with the trust, and if decedent chooses the attorney option 302 for the will, can assist the attorney with this as well. Having these gone through and set down can lower attorney costs by lowering the amount of work the attorney needs to charge for, and can result in a will and/or trust with fewer errors or misunderstandings.

In addition, the system 10 can work with decedent and/or user to collect any helpful supplemental information 308 to assist any future will executors or trustees. This supplemental information can include such things as the location of any pieces of property (real estate or personal) or money, location of any keys to such things as the residence, car, boat, or safety deposit box. Any passwords or security codes can also be included. Inclusion of this supplemental information can make it easier for the executor or trustees to access any such items that they need to.

In other embodiments, a will or trust can be created, executed, and stored in a digital formal 310 by any means suitable in the art. The system 10 can ask the user a series of questions via computer. The user directly inputs requested information and answers a series of question. This information is then taken by the system 10, placed within a will or trust template, and the proper document created. Then the user can execute the document 312 via any suitable means of digital execution in the art. These can include, e.g., conducting a facial recognition scan, finger or thumb print, virtual signature, or other means in the art. The executed document can then either be uploaded to a suitable place for storage 314, such as a secure digital server, or into a local or county courts system; or printed and stored 316.

In some embodiments, the system 10 can be directed to time stamp one or more pages of any of the documents herein, or additional or supplemental documents, to provide proof of when they were created. Further, the system 10 can be directed to provide a watermark on one or more pages of any of the documents herein, or additional or supplemental documents a watermark. The watermark can be used to identify a party who owns, is associated with, or oversees the system.

Further, a supplemental audio or video recording can be created 318 explaining any will or trust decisions, and making the decedent's reasons and thoughts clear. While a recording cannot replace a written and legally compliant will or trust, it can provide additional evidence supporting any such will or trust. Further, such a recording can avoid conflicts and hurt feelings by making it clear to all that these are the decedent's wishes. Further, the decedent can go into deeper and further detail explaining decisions and the reasons for the terms of the will or trust than would likely be within the four corners of the respective document.

In other words, the system enables the user, while in the respective portals for the and the pre-transition care and emergency care module 100, and the Estate and inheritance planning and execution module 300, to provide a number of permissions, forms, and information tailored around a decedent's specific needs.

In further application platform embodiments, the system provides additional services. The needs of friends and relatives of the decedent are likely to go well beyond estate or planning issues. Children may have lost a parent, siblings may have lost siblings, friends have lost their friend. In addition, younger relatives may have lost a chance to clearly remember the decedent. Grandchildren may have lost a grandparent, but they have also lost a chance to form any more solid memory and bond with their lost grandparent.

The decedent (and possibly user) can help with this through the system's 10 grief assistance and memories module 400. This grief assistance and memories module 400 provides multiple ways to help those left behind stay connected. The decedent can create video or audio messages 402. These can be general messages, or specific messages targeted to specific people. Messages can be personal and tailored. For example, if a grandfather and grandson go fishing together a lot, the grandfather can leave a message about fishing together. The messages can be released upon death, or toward specific people at specific times.

Further, the decedent can create one or more virtual activities 404 and designate the message to be accessed by any person(s) they choose. This experience can be enhanced if the video is in a format such as Virtual Reality, which can make the viewer feel more like they are there with the decedent. The decedent can also, for example, create a set of messages or activities, one to be released upon death, another a year later, yet another five years later, and so on. The videos can also be arranged to be released at specific times.

In an example, Dirk, a grandfather, can create and set up a set of videos for his grandson Robert at specific milestones, where Dirk's understanding or even advice can be shared with Robert when needed. Dirk can give Robert the links with instructions of when each is to be opened, or he can leave the videos with a trusted person, to be shared with Robert at the appropriate times. For example, there may be a video when Robert has graduated High School and is concerned about his future. Or when Robert and his first girlfriend break up. These videos can be in video format, or created and run in VR to give Robert more of the feeling of his grandfather being there. As examples, a VR activity video can be made, to be given to Robert when he is old enough to take an interest in, e.g., fishing, pool, or basic auto mechanics. These videos and/or VR interactions can provide Robert with an important connection with his grandfather, and useful support.

As a few more examples, the decedent can create a video where they go through a recipe. The decedent can have a “movie watch” where they play a movie they like, and comment on it, and a friend or relative can join them. The videos can be for other activities, such as talks, readings, and the like. In addition, if, for example, the decedent has younger children, or grandchildren, and has things they would like to teach them, they can use these recordings to do so. For example, a decedent may have wanted to teach their child or grandchild how to do things such as fish, crochet, play a violin, or how to change a tire. The decedent can make a video going through how to do an activity or task, which the child or grandchild can access and use to learn. Besides imparting information, these videos can help maintain a connection between a decedent and their children or grandchildren. As an example, if Caroline wants to learn the basics of playing a piano, she can access the recordings left by her grandfather, in which he goes through the steps carefully. If something like VR technology is used, Caroline may feel like she is in the same room with her grandfather. Caroline can refer to the recordings as often as she likes until she learns to play the piano. In this way, Caroline can maintain a sort of connection with her grandfather, keeping memory of him and easing the transition

Information can also be supplied about a number of specified matters via a module for Supplemental Matters module 500. A file can be created 502 by the user and supplied with information related to a further specified matter. This file and information can be accessed at the appropriate time 504 to help those working with decedent or decedent's estate. Further supplemental files are represented here as 502a, 502b, 502c, 502d. These files can be created, and each accessed 504a, 504b, 504c, 504d, when appropriate. As an example, decedent may create a file 502 regarding pets, including information about who to give any pets to and/or information about their care. Another file 502a may be created about insurance policies, including what policies the decedent has, and what company(ies) hold them. Yet another file 502b may concern information about the location of bank accounts. Yet another file 502c may disclose the location of any financial records or tax records, including contact information for any current or former accountants. All this information may be helpful to those managing decedent's affairs after death. A further file 502d can be a secured file with decedent's passwords for various accounts or files, and the location of access items such as any safe deposit box keys.

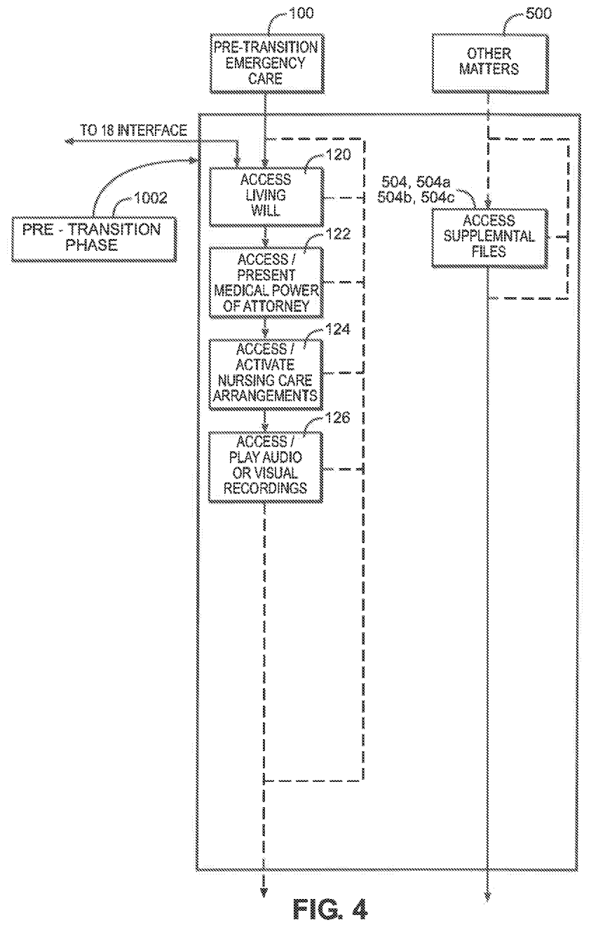

Turning to FIG. 4, moving to the Pre-transition phase 1002, now that the software has been programmed 20 and placed 22, 24 into the system 10 and the at least one user has set up the software use through the modules 100, 200, 300, 400, 500, use of the software through pre-transition matters-before the death of the decedent-begins.

What modules of the system 10 and programmed software are used, and steps a user, caretaker or holder of power of attorney will need to go through are likely to depend on what pre-death situation(s) the decedent has. This can be somewhat unpredictable, which makes the setting up steps of the Initial Transition Preparation phase 1001, covering the possible upcoming but unknown issues, all the more important.

If the decedent ends up in an end-of-life care type situation, the living will the system 10 assisted with creating 102, 106 can, depending upon the situation, be accessed and presented by either the decedent or designated user 120. The medical power of attorney can also be presented by the decedent or user 122. If the decedent needs to enter nursing care, of their own decision or the holder of the medical power of attorney, the nursing care arrangements can be accessed and activated 124. Any audio or visual recordings about these matters can, as appropriate, be accessed and played 126. The system 10 is accessed via the computer 12, directly or via the server 16. Information files on any supplemental matters that are needed at this time can be accessed 504, 504a, 504b, 504c, 504d.

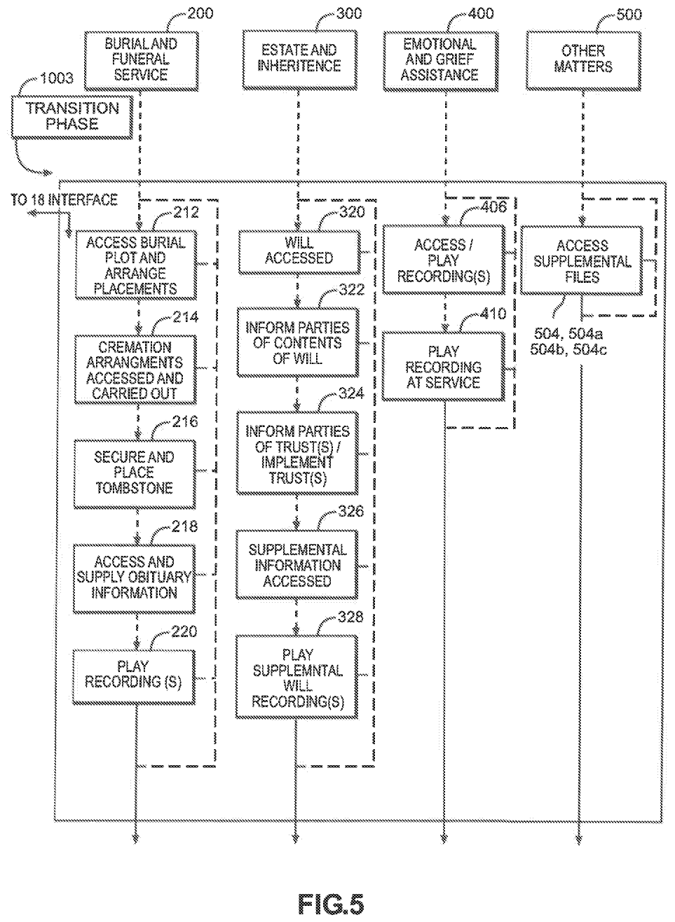

Turning to FIG. 5, steps and actions for dealing with the Transition Phase 1003 are taken. The Transition Phase 1003 is understood to cover the time period immediately after the passing of the decedent, and the immediate arrangements to be taken care of in this time. This time is typically understood to be within the next few days, up to a week or two, of passing. When the decedent passes, friends and relatives are in grief, often less able to think clearly than at most any usual time. This is while any executors or others designated to handle decedent's affairs (which are often friends and relatives in grief) suddenly have a set of complicated matters thrust upon them by the outside event of death. There tends to be a limited time, often within a few days of death, in which a number of matters need to be handled, placing often-grief-stricken people under added pressure. This is often when the system 10 can be of most help.

Turning briefly to FIG. 2 as well as FIG. 5, the successive user(s) access the system 10 and its transitioning application software 14 via interface 18. As noted before, this access can be granted by password, fingerprint, voice or face recognition, or other form of access in the art. The successive user(s) can access the system 10 and software 14 by directly accessing a computer 12, or accessing a server 16 on a network 19 by accessing the server 16 through a computer 16, or directly accessing the server 16 itself.

Returning to FIG. 5, once the system is accessed, the successive user can begin burial and funeral service planning 200. If the decedent acquired a burial plot 202, the successive user can access the information about the burial plot and arrange for placement of the decedent in the plot 212. If the decedent made arrangements for cremation, or at least made clear cremation was their preference 204, the information and any arrangements about cremation (such as where any ashes are to be placed or scattered) 204 are accessed and carried out 214.

Whether decedent is buried or cremated, if decedent has arranged for a tombstone 206, the successive user can carry out these arrangements and secure and place the tombstone 216.

If Obituary information was supplied 208, the successive user can access and supply this obituary information 218. Instead of making a number of calls, and looking things up, and possibly spending hours or days tracking down various pieces of information for the obituary when already under pressure and grief, the successive user is able to simply access and send the information to a funeral home, newspaper, or other appropriate party. Further, the successive user has to do much less speculating what the decedent would have wanted the obituary to say, since the decedent participated in crafting it.

If decedent chose to make any audio or video recordings 210, any of these recordings that were designated to be played in this time period are given, or played to, any person or group the decedent has designated 220.

Depending upon circumstances and timing, the Estate and inheritance planning and execution module 300 may need to be implemented during the Transition Phase 1003 (in the few days or weeks after death), later during the Post transition phase 1004 (weeks to months, or even within several years of death), or across both.

The time at which wills are read and acted upon by the executor(s) can vary, but the will, however It was prepared, may be accessed by the executor or other designated party 320. This access can be, depending upon state legality, to a document or digitized form. The will can then be read or otherwise disseminated to the appropriate parties at this time, and they be informed of the contents of the will 322. Any appropriate parties may also be informed of any trusts 324 (which may be noted in the will). Any supplemental information that was entered to help carry out the will 308 can now be accessed by the executor or other appropriate party 326. The creation and access of this supplementary information can be invaluable to those carrying out the will, as they do not have to scramble and search for items such as safe deposit box keys, passwords, and the location of specific items. This makes carrying out the decedent's wishes much easier and smoother.

If supplemental recordings were created 318 in support or explanation of the will (and any trusts), these can be accessed and played to the designated parties. For example, if one beneficiary was given a house while the other was given cash, or one beneficiary was given more than another, or one had a trust set up for them while the other was given money outright, or someone was left out of the will, these recordings can explain these decisions to everyone in the decedent's own words. This can serve two purposes. First, these recordings can provide evidence supporting the will, making it clear that like them or not, these were the decedent's intentions. Second, seeing the decedent explain their decisions in their own image and words can decrease the chance of disputes among those left behind. These can foster understanding, and even acceptance, of decedent's decisions. Even if someone does not agree with a decision, or is even distraught by it; even if they hate the explanation or hold the decision against the decedent, the recording can still help in that the displeased party may, having seen a video about the decision, understand it was decedent's decision and only hold it against the decedent, and not against anyone else.

As an example, there is a father and two siblings, Anne and Barney. In the will, the father leaves significantly more to Anne than Barney. Without further explanation, Barney may wonder if their father loved Anne more. Was he unworthy in some way? Was that a planned insult? This can foster resentment, or at the least distance, from Barney towards Anne. They could well become distant or even estranged. But because this system 10 provided a way for the father to record and leave a video to Barney, he chose to. The video explains to Barney that because Anne has two children to be looked after and he had none, he decided to leave Anne more. Barney may accept the reasoning that this was really about providing for grandchildren as well as children, Barney may not accept or agree. However, Barney is more likely to understand this was his father's decision and either way, not hold the decision against Anne. Distance or other problems between them are now much less likely.

As will be shown, portions of the Grief assistance and memories module 400 may become involved any time from decedent's death to the distant future. Any video or audio recordings, including those containing messages, that were created by decedent to help others in the immediate aftermath of their passing can be played for any designated person 406 at any point during this time. The decedent may even have an audio or video recording to be played at their own service 410.

Any supplemental information files that were created 502 502a, 502b, 502c, 502d can be accessed 504, 504a, 504b, 504c, 504d. As with all such files herein, these can have instructions on them, within the system 10, when they should be accessed and who is designated to do so. Any of these files that need to be accessed immediately after death are, and any instructions that can be carried out are 504, 504a, 504b, 504c, 504d.

As an example, when the decedent passes, care of any pets will need to be arranged. These animals cannot wait weeks or months for settlement of all financial issues. Arrangements as to who will take any of these pets, instructions, and even supplementary information about matters like medical issues, medications, or treatments can also be included. This can save a lot of disputes on who should take care of any pets, and the inclusion of extra information can prevent problems, or even accidental death of the pet(s).

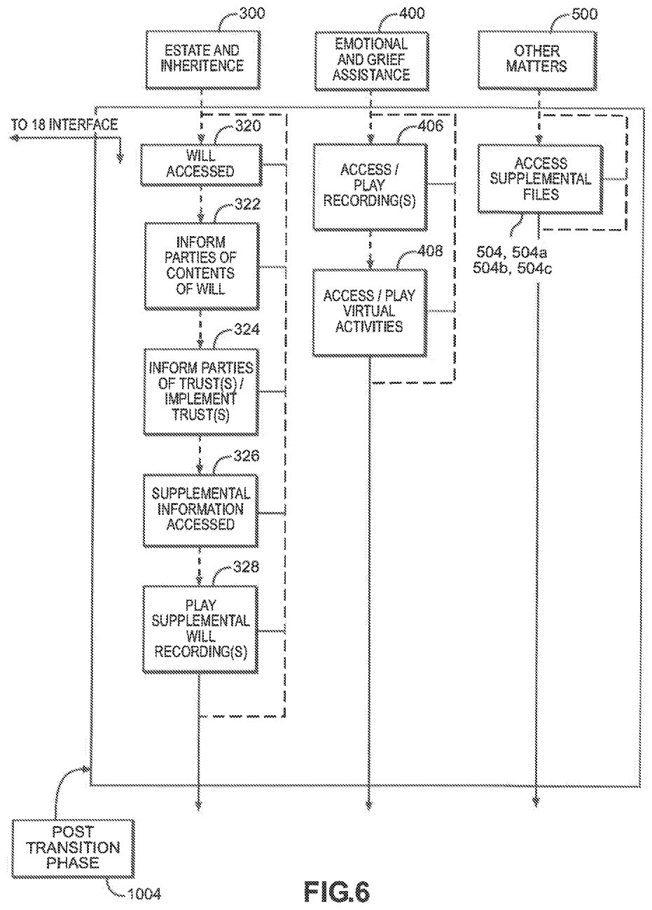

Turning to FIG. 6, after the immediate time of passing of the decedent, there will be a number of issues and arrangements to work through over the coming weeks, months, and if there are extra complexities (such as managing of established trusts) years, comprising a Post Transition phase 1004. With medical and funeral issues resolved, the Post transition phase 1004 tends to focus more (though sometimes not exclusively) on financial and legal matters and helping people through grief.

Turning as well to FIG. 2, as with previous phases, the successive user(s) access the system 10 and its transitioning application software 14 via interface 18, via computer 12, or by accessing a server 16 more indirectly. Instead of having to scramble around, looking for documents and other information and remember intentions, the documents and information are immediately available for the successive user to act upon.

Returning to FIG. 6, any matters of the Estate and inheritance planning and execution module 300 that have not been resolved in a previous phase are to be completed and resolved in this phase. If it has not already been, the will may be accessed by the executor or other designated party 320. The will can then be read or otherwise disseminated to the appropriate parties, and they be informed of the contents of the will 322. Any appropriate parties may also be informed of any trusts 324 (which may be noted in the will). And if this has not been done yet, supplemental information that was entered to help carry out the will 308 can now be accessed by the executor or other appropriate party 326.

If supplemental recordings were created 318 in support or explanation of the will (and any trusts), these can, if not already, be accessed and played 328 to the designated parties.

Here is an example of the system 10 at work to help those who need to make arrangements. The decedent, Sonia, has passes away. Sonia let it be known that her son Joseph would be in charge of handling her estate and other related matters. Joseph accesses the system 10. Sonia had decided to be buried with a tombstone. Instructions and information about the burial plot and tombstone are found by Joseph. Now he knows where Sonia is to be buried and exactly what she wanted for a tombstone. Further, Joseph accesses complete information about funeral arrangements. All Joseph has to do is contact the designated funeral home and carry them out. The funeral home requests information for an obituary. Joseph simply accesses this and hands it over. These matters that might have taken hours or days, instead, take minutes.

Instead of having to look around for a will and other documents, the system 10 provides them, or their locations. Joseph can simply find them now. The will is read, and Joseph can carry it out. Because of the system, directions are clear, and Joseph can carry out the will with fewer problems. Don, a nephew, is unhappy about a provision in the will leaving a family shotgun to someone else. Luckily, though, Sonia left a recording explaining this and other decisions of the will. Don is disappointed not to get the heirloom shotgun, but understands the reason. Sonia had decided to set up a college trust for her only grandchild, Katie. Documents and information about the trust had been filled out and signed by Sonia, so that Sonia or Joseph could take these and the will to an attorney and have this taken care of. Sonia also has a life insurance policy. The system lists this, who the beneficiaries are, and who the policy is with. This information makes it much easier to track down the insurance company and have the policy paid out. This is similarly true of Sonia's bank account. While all this has been hard on Joseph, it is considerably easier than it might have been, thanks to the system 10.

Part or all of the Grief assistance and memories module 400 may be used at this time. Any video or audio messages that were created by decedent designated to be played in this phase can be played for any designated person to help during this time 406.

As noted previously, the grief assistance and memories module 400 provides multiple ways, as the death and funeral service recede, to help those left behind through their grief and to stay connected. If the decedent has created video or audio messages 402, these can be played to any designated persons during this period. These can be a single, or series, of messages to any, or a set of, designated persons 406. These messages can be crafted to give any last thoughts or advice, help them with their grief, or say other things the decedent wanted to. If the decedent opted to create one or more virtual activities 404, any designated person or groups can access and run any of these virtual activities 408.

Any supplemental information files that were created 502, 502a, 502b, 502c, 502d but not previously accessed are accessed 504, 504a, 504b, 504c, 504d in this phase. Files involving matters and information that did not need to be immediately accessed after the decedent's death, but do need to be accessed to help with estate issues, are accessed now. A few examples of these kind of files from the previous examples herein include insurance policies 502a, bank information, 502b, and tax and other financial information 502c

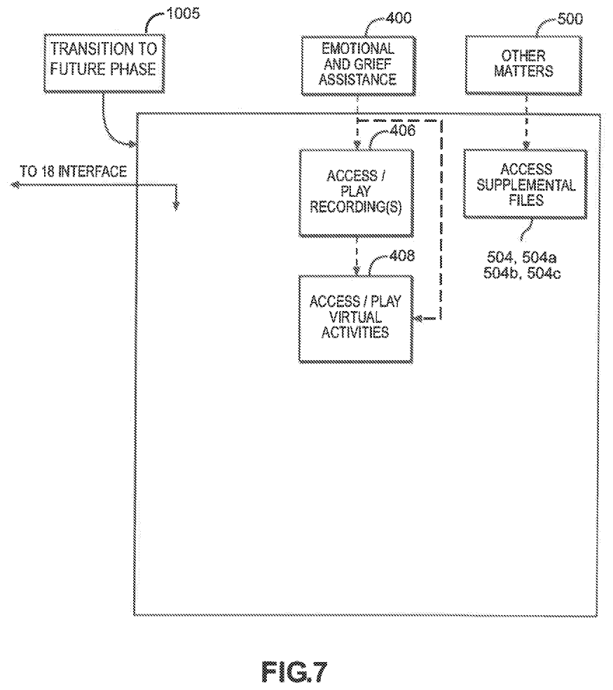

Turning to FIG. 7, the Transition to Future phase 1005 is entered. This phase begins after the Post transition phase 1004. While other activities or elements may carry into this phase from other phases (e.g., management of an ongoing trust or extended dispute), typically, legal and financial matters of the estate have been settled. While a firm time frame is not always easy to predict, this phase typically begins within a few months of the decedent passing. The transition to Future phase 1005 may be short, or it may last for decades. It may even last for the duration of the lives of family or friends of the decedent. It typically is centrally, or completely, about helping relatives and friends of the decedent handle ongoing grief, keeping memories of the decedent alive, and maintaining an extended connection to the decedent.

If the decedent has created recordings 402 and activities 404 meant for relatives or friends of the decedent to access over a longer-term timeline, these, as previously noted, can be accessed by designated person(s) at specific times 406, 408. The decedent can make these recordings for specific people or groups. For example, the decedent could have made a message for her daughter for one year from death, two years from death, etc. Or in another example, a decedent could have created family messages for each holiday, for some period of years in advance.

If the decedent opted to create one or more virtual activities 404 any designated person or groups can access and run any of these virtual activities 408.

For example, if a father or grandfather left a VR video of a “virtual camping trip” the family can join him for this trip. Or a grandmother leaves a VR Christmas time. Instead of simply missing her at Christmas, a family can play the video and feel she is there. Feel connected. This obviously does not eliminate the grief, but is likely to provide a way to lessen it, and to talk about her instead of stewing in an awkward silence.

In another example, a father leaves a video on how to change a tire, or other thing a father normally teaches his children. His kids, Bobby and Susan, go out to Susan's car, play the video, and change the tire. They can learn, from their father, how to change a tire just as he'd wanted them to, while Bobby and Susan can still learn from their father and feel connected.

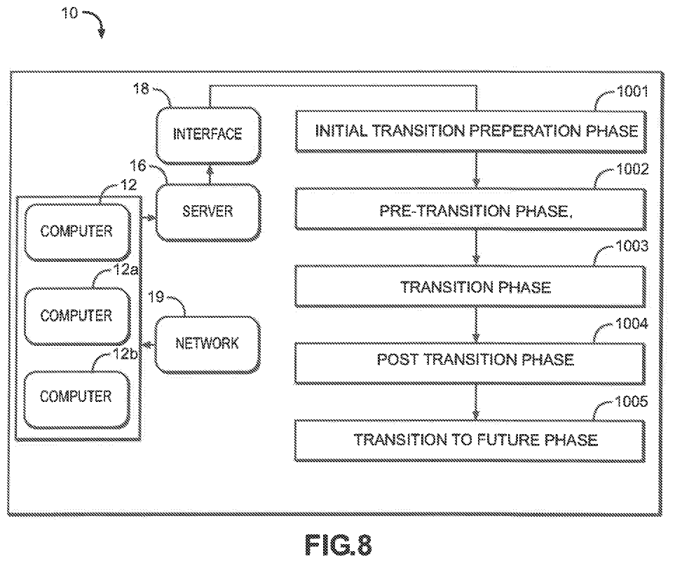

Turning to FIG. 8, the at least one server 16 can be set up to be run by a central server. The server 16 can be on a network 19 with multiple computerized devices, represented herein as 12, 12a, 12b. The software 14 can be placed on and accessed by the computerized devices 12, 12a 12b, through application software placed on the computerized devices 12, 12a 12b. In some embodiments, the users interact with the server 16 via the computerized devices 12, 12a 12b. Information, files, recordings, and other data can be stored on the server 16, and the information, files, recordings and other data of each decedent secured on the server 16 with centralized securing software. Another party can handle this, and maintain the server, via a subscription or one-time fee service.

In other embodiments, the decedent, user or other designated party can create a picture bank of uploaded and stored pictures. The decedent can place specific pictures within specific files in the picture bank. Further, access to different files within the bank can be decided and given out accordingly. For example, anyone may be able to access one picture bank file, while access to another picture bank is limited to a specific group of people, or one person.

The system 10 can also be set such that upon a specific event, either a specific picture file, or access instructions to the file, can be emailed to a specific person or group, or the file can placed on a public wall for access. Access can also be set to be given, or a file sent to a person or set of people, at any appropriate time.

In an example, a set of pictures is selected for the obituary and to be displayed at the funeral service for decedent. These are placed in a file, public access is not restricted, but the file is set to be emailed to a selected funeral home. When the system enters the Burial and funeral service planning module 200, during the transition phase 1003, the picture files are sent to the funeral home and Jack who has been designated to plan the service, before or as obituary information is accessed 218. Alternatively, they may be sent a link from which they can access the file.

During funeral planning, there is no need for Jack to go ask anyone for pictures, chase down photo albums, look through a house for photos, try to access the decedent's computer looking for pictures, or the other steps to get ahold of some pictures. Jack and/or the funeral home already have the preferred pictures, saving much stress and time. Further, other documents related to the pictures can also be placed in the picture files. For example, further instructions or readings, etc can be left in the picture file for the computer, where Jack and the funeral home can access them. Pictures from the file can be shown at the service, along with any recordings that are played 410.

In another example, the decedent or user creates a picture file(s) as part of the Estate and inheritance planning and execution module 300 related to the estate. These pictures can be of, for example assets like antiques or jewelry, a home, vehicles or other items. As part of the transition phase 1003 and/or post transition phase 1004, before or during the point at which any supplemental information is accessed 326, the picture file is either sent, or a link or other method of accessing the file, is sent to Margaret, the executor handling the estate. Or the pictures may be simply left open on a wall, so that Margaret and all the other heirs have a clear and mutual idea of items within the estate.

The identification of these items can be of great assistance, both in helping Margaret identify important estate items, and in making it clear what is present and what is not, preventing arguments and acrimony between the heirs. Instructions may also be included in this file, such as who should get which miscellaneous items not included in the will.

In another example, the decedent creates picture files for the Grief assistance and memories module 400, for Anne, Brian and Cassie, as well as picture files for anyone who wants them. This can be done possibly around the point where video or audio files are created 402 and/or virtual activities are created 404. In the transition to future phase 1005, access to specific picture files, or the files, can be transmitted to Anne, Brian, and Cassie, perhaps around the time recordings are accessed and played 406 and virtual activities are accessed and played 408. The other file for public access is placed on a public wall.

As has been stated, picture files, with pre-determined access, can be created for any appropriate point in the process, and sent to any specific person or set of persons.

The system herein 10 provides a complete system for enabling a decedent, and those responsible for handling decedent's affairs, to provide decisions, information, steps, and documents for completion for turnkey handling in advance (including the steps of legal and financial preparation), for medical and end of life matters. Use of this system 10 will save everyone, including decedent, family, friends, and those handling matters for the decedent, the related stress, feelings of chaos, uncertainty, and even help with grieving, by providing a systematic and organized means to implement pre- and post-mortem decisions, and take pre-determined actions to assist those loved ones left behind.

The system 10 gives the user the chance to plan for their entire life span, which can begin as younger users, and it provides older users with comfort knowing that their final needs (financial and emotional) will be taken care of, for them and their loved ones.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A method of providing a comprehensive estate and life planning transitioning system, comprising the steps of;
programming transitioning system software,
providing at least one computerized device configured to be accessed by at least one user,
placing the system software on the at least one computerized device,
providing an interface to the at least one computerized device,
providing a set of tasks to be completed and placing each of these tasks within a set of modules,
completing the set of tasks within the set of modules across a set of phases via the system software using the interface and the at least one computerized device,
wherein the set of modules include;
a burial and funeral service planning module,
an estate and inheritance planning and execution module, and
an emotional and grief assistance module,
and wherein the set of phases is comprised of;
an initial transition preparation phase,
a transition phase, and
a post transition phase.

2. A method of providing a comprehensive estate and life planning transitioning system according to claim 1, wherein the set of modules are further comprised of:
a pre-transition care and emergency care module, and
an other matters module.

3. A method of providing a comprehensive estate and life planning transitioning system according to claim 1, wherein the set of phases further comprise:
a pre-transition phase, and
a transition to future phase.

4. A method of providing a comprehensive estate and life planning transitioning system according to claim 1, wherein the at least one computerized device is comprised of:
at least one personal computer, laptop, server, smart tablet, smartphone, or combination thereof,
at least one server,
or a combination of these.

5. A method of providing a comprehensive estate and life planning transitioning system according to claim 5, wherein a server is provided, and the system is configured so that the software on the server can be accessed either
directly,
interactively via the at least one computerized device,
or both.

6. A method of providing a comprehensive estate and life planning transitioning system according to claim 1, wherein the at least one computerized device is comprised of:
at least one personal computer, laptop, server, smart tablet, smartphone, or combination thereof.

7. A method of providing a comprehensive estate and life planning transitioning system according to claim 1, providing the further steps of;
configuring the system so that at least one user can access the software on the at least one computerized device, and the at least one user can enter at least command to the system, via the interface,
wherein the at least one computerized device is comprised of,
at least one personal computer, laptop, server, smart tablet, smartphone, or combination thereof,
at least one server,
or a combination of these.

8. A method of providing a comprehensive estate and life planning transitioning system according to claim 1, wherein the initial transition preparation phase, comprises the steps of;
setting up the system with access criterion,
or presenting the user with an option of
working with an attorney to prepare a living will, and assisting a user with working with the attorney, or
obtaining a state-specific living will template form and assisting the user to prepare the living will from the form,
or presenting the user with an option of
working with an attorney to prepare a medical power of attorney, and assisting a user with working with the attorney, or
obtaining a state-specific medical power of attorney template form and assisting the user to prepare the living will from the form,
or providing for the user to name a personal doctor,
or assisting the user to make arrangements for nursing home care,
or assisting a user with the creation of audio or video media recordings with the computer, server, or both,
or time stamping and storing any living will or medical power of attorney that is created,
or, either
assisting a user to obtain a burial plot and storing accessible information about the burial plot, or
assisting a user to arrange a cremation and storing accessible information about the cremation,
or assisting the user arrange for a tombstone and storing accessible information about the cremation,
or assisting a user with obtaining and storing accessible information about the obituary,
or any combination of these steps.
or, either
providing access to a group of pre-screened attorneys within an accessible database, or,
assisting a user with working with a user-chosen attorney and assisting with storing any work product from the user-chosen attorney into the at least one computerized device,
or, either
assisting a user in preparing a list of information and intentions to draft a will, or
providing a state-specific will form to be filled out, and assisting a user in filling out the form,
or providing a digital checklist of steps, questionnaire, or both to assist a user in creating one or more documents,
or assisting a user in preparation of at least one trust,
or assisting a user in collecting and accessibly storing helpful supplemental information,
or storing at least one executed document by either:
uploading the at least one executed document to a digital server,
uploading the at least one executed document into a local or county court system,
or printing and storing the at least one executed document,
or time stamping one or more pages of at least one document,
or water marking one or more pages of at least one document,
or assisting a user in creating and storing at least one supplemental audio or video recording,
or assisting a user in creating and storing at least one virtual message or activity,
or assisting a user with creating and storing Information about at least one supplemental matter,
or a combination of these steps.

9. A method of providing a comprehensive estate and life planning transitioning system according to claim 8, wherein an AI system is configured to guide a user through preparation of one or more legal documents.

10. A method of providing a comprehensive estate and life planning transitioning system according to claim 8,
comprising the further steps of;
collecting a group of pre-screened attorneys,
placing information about the group of pre-screened attorneys within an accessible database,
and making the information accessible to a user.

11. A method of providing a comprehensive estate and life planning transitioning system according to claim 8, providing the further step of;
configuring the system so that a user can execute the document by
facial recognition scan,
finger or thumb print,
virtual signature,
or a combination of these.

12. A method of providing a comprehensive estate and life planning transitioning system according to claim 8, wherein the virtual message or activity is created using virtual reality technology.

13. A method of providing a comprehensive estate and life planning transitioning system according to claim 3, wherein the pre-transition phase comprises the steps of;
assisting the user with creating at least one living will, and assisting the user in accessing the at least one living will from the at least one computerized device,
or assisting the user with creating at least one medical power of attorney, and assisting the user with accessing the at least one medical power of attorney from the at least one computerized device,
or assisting the user with creating at least one nursing care arrangement, and assisting the user with accessing the at least one nursing care arrangement from the at least one computerized device,
or assisting the user with creating at least one audio or visual recording, and assisting the user with accessing the at least one audio or visual recording from the at least one computerized device,
or assisting the user with creating at least one piece of supplemental information, and assisting the user with accessing the at least one piece of supplemental information from the at least one computerized device,
or any combination of these steps.

14. A method of providing a comprehensive estate and life planning transitioning system according to claim 1, wherein the transition phase comprises the steps of;
assisting a user with arranging a funeral service, and assisting the user with accessing the information about the funeral service from the at least one computerized device,
or assisting a user with obtaining a burial plot, and assisting the user with accessing the information about the burial plot from the at least one computerized device,
or assisting a user with arranging a cremation, and assisting the user with accessing the information about the cremation from the at least one computerized device,
or assisting a user with arranging a tombstone, and assisting the user with accessing the information about the tombstone from the at least one computerized device,
or assisting a user with obtaining obituary information, and assisting the user with accessing the obituary information from the at least one computerized device,
or assisting a user with creating at least one audio or video recording, assisting the user with accessing the at least one audio or video recording from the at least one computerized device, and playing the audio or visual recording to at least one designated person or group,
or assisting a user with creating a will, and assisting a user with accessing the will from the at least one computerized device,
or assisting a user with creating at least one trust, and assisting a user with accessing information about the at least one trust from the at least one computerized device,
or assisting a user with creating supplementary information, and assisting a user with accessing the supplementary information from the at least one computerized device,
or a combination of these steps.

15. A method of providing a comprehensive estate and life planning transitioning system according to claim 1, wherein the post transition phase comprises the steps of;
assisting a user with creating a will, and assisting a user with accessing the will from the at least one computerized device,
or assisting a user with creating at least one audio or video recording, assisting the user with accessing the at least one audio or video recording from the at least one computerized device, and playing the audio or visual recording to at least one designated person or group,
or assisting a user with creating supplementary information, and assisting a user with accessing the supplementary information from the at least one computerized device,
or a combination of these steps.

16. A method of providing a comprehensive estate and life planning transitioning system according to claim 3, wherein the transition to future phase comprises the steps of;
assisting a user with creating at least one audio or video recording, assisting the user with accessing the at least one audio or video recording from the at least one computerized device, and playing the audio or visual recording to at least one designated person or group,
assisting a user with creating at least one virtual activity, assisting the user with accessing the at least one virtual activity from the at least one computerized device, and playing the audio or visual recording to at least one designated person or group,
or a combination of these steps.

17. A method of providing a comprehensive estate and life planning transitioning system according to claim 1, wherein at least one computerized device is comprised of a central server and at least two computerized devices,
and comprising the further step of connecting the at least two computerized devices to the central server.

18. A method of providing a comprehensive estate and life planning transitioning system according to claim 1, providing the further steps of;
creating at least one picture bank,
creating at least one picture file within each picture bank,
uploading and storing at least one picture within each picture file,
and granting access to the at least one picture file to at least one person,
wherein the access can be configured to be either open, restricted, or via a link sent to at least one person with pre-approved access.

19. A method of providing a comprehensive estate and life planning transitioning system according to claim 8, wherein preparing the medical power of attorney is further comprised of the steps of either;
creating and placing information within the at least one computerized device regarding the medical power of attorney, proof of execution and proof of notary of the medical power of attorney,
creating and placing a living will within the at least one computerized device, or both.

20. A method of providing a comprehensive estate and life planning transitioning system according to claim 8 wherein any audio media are in the format of;
0.3gp, .8svx, .aa, .aac, .aax, .act, aes3, Adaptive differential pulse-code modulation, Adaptive Multi-Rate audio codec, Advanced Systems Format, Advanced Audio Coding, .aiff, .alac, .amr, .ape, .au, .awb, Audio Video Interleave, Broadcast Wave Format, .cda, Core Audio Format, Digital Audio Tape, .dss, .dvf, Dialogic ADPCM, .flac, GBA Sound Format, .gsm, .iklax, .ivs, Linear Pulse Code Modulation, .m4a, .m4b, .m4p, MIDI, .mmf, MPEG-1, MPEG-4, .mp3, .mp4, .mpc, .msv, Multimedia, Musepack, .nmf, .ogg, .oga, .mogg, Original Sound Quality, Pulse-code modulation, .opus, QCP, .ra, .rm, .raw, .rf64, .sin, Speex, .tta, Theora, .voc, Vorbis, .vox, .wav, .wma (Windows Media Audio), .wv, .webm, XM,
or any combination of these,
and wherein any visual media are in the format of;
MP4, MOV, WMV, AVI, AVCHD, FLV, F4V, and SWF, MKV, WEBM, MPEG, or MPEG-2, IMAX™
or any combination of these.
